(19) United States
(12) Patent Application Publication
(10) Pub. No.: US 2005/0169275 A1
(43) Pub. Date: Aug. 4, 2005

(54) Method for transmitting multi-protocol label switch protocol data units

(75) Inventors: Zhangzhen Jiang, Shenzhen (CN); Jianfei He, Shenzhen (CN); Jianyun Zhu, Shenzhen (CN)

Correspondence Address: ROTHWELL, FIGG, ERNST & MANBECK, P.C., 1425 K STREET, N.W., SUITE 800, WASHINGTON, DC, 20005, US

(73) Assignee: HUAWEI TECHNOLOGIES, CO., LTD., Shenzhen (CN)

(21) Appl. No.: 11/001,312

(22) Filed: Dec. 2, 2004

(30) Foreign Application Priority Data
Dec. 3, 2003 (CN) 2003101200736

(51) Int. Cl. H04L 12/56

(52) U.S. Cl. 370/392

(57) ABSTRACT

A method for transmitting high-level PDUs (Protocol Data Units) over low-level protocol and method for transmitting MPLS (Multi-protocol Label Switch) PDUs so as to improve transmission efficiency, resource utilization, and network performance of MPLS network traffics. The method for transmitting MPLS PDUs includes the following steps: A. adding the pending MPLS PDU to PIA (Payload Information Area) field of a GFP (General Framing Procedure) data frame; B. transmitting the GFP data frame to the destination node via a transmission network; C. retrieving the MPLS PDU from the PIA field of the GFP data frame at destination node.

### FIELD OF THE INVENTION

The present invention relates to a method for transmitting high-level PDUs (Protocol Data Units) over low-level protocol, particularly to a method for transmitting MPLS (Multi-protocol Label Switch) PDUs on the basis of GFP (General Framing Procedure).

### BACKGROUND OF THE INVENTION

MPLS is a standard protocol of IETF (Internet Engineering Task Force). MPLS is a label-based IP (Internet Protocol) routing method and pertains to the scope of L3 switching technology; it employs a label-based mechanism to separate routing from forwarding; the network path of any packet is determined by the label, and data is transmitted through the LSP (Label Switch Path); MPLS converts L3 packet switching into L2 switching in an IP network.

FIG. 1 shows the network structure of MPLS. A MPLS network 101 comprises LSRs (Label Switch Routers) 104 in core part and LERs (Label Edge Routers) 103 in edge part. LER 103 is designed to analyze IP packet headers, execute L3 network functions, and decide corresponding transport levels and LSPs; it is connected to the external network 102 from which to receive external data packets 105; LSR 104 is designed to establish LSPs, execute label switch mechanism and QoS (Quality of Service), and forward data packets 106 in the MPLS network; it comprises a control unit and a switching unit, resides in the network, and is connected to LER 103 and other LSRs 104.

The label switching workflow of MPLS is as follows: first, establish a routing list and a label mapping list in LSR through LDP (Label Distribution Protocol) and conventional routing protocols such as OSPF (Open Shortest Path First); during network operation, the LER at entry to MPLS core network receives an IP packet from the external network, accomplishes L3 network functions, and adds a label to the IP packet; next, the data packet is transmitted in LSP, the LSR doesn't perform L3 processing for the packet; instead, it only forwards the packet via the switching unit according to the label; the data packet is transmitted to the other end (i.e., outlet) of the network finally; the LER at MPLS outlet removes the label from the packet and forwards the packet through the corresponding protocol of the external network.

MPLS technology isolates label distribution mechanism from data stream, it can be implemented independently to specific data link layer protocols, thus MPLS can support diverse physical layer and data link layer technologies. Presently, MPLS over FR (frame relay), MPLS over ATM (Asynchronous Transfer Mode), MPLS over PPP (Point-to-Point Protocol) links, and MPLS over IEEE (Institute of Electrical and Electronics Engineers) 802.3 LANs has been achieved. Utilizing MPLS-based network to forward IP traffics simplifies inter-layer routing & forwarding process, thus accelerates MPLS switching, and enhances network efficiency; in addition, MPLS can transmit traffics of different levels ; it combines high speed and flow control capability of switch and flexible functionality and QoS of router.

GFP (General Framing Procedure) is a new framing protocol defined in proposal G.7041/Y.1303 of ITU-T (the International Telecommunication Union-Telecommunication Standardization Sector). GFP can be used to transport length-fixed data packets or length-varied data packets over high speed data channels, because it follows HEC (Header Error Check) in ATM to delimitate frames. GFP exploits point-to-point transmission capability of MODEM and transmits input data stream in sequence, significantly simplifying data link layer synchronization and data frame delimitation. Unlike the delimitation mechanism (i.e., utilize header mark, escape byte “7D”, “7E”, etc.) of HDLC-based framing protocols, GFP doesn't need specific line encoding for PDUs (Protocol Data Unit) and thereby reduces requirements for the logic circuit. GFP can assign QoS control function for the client layer, which reduces overhead; therefore, GFP is better than ATM in this aspect. Reduced execution complexity makes GFP particularly suitable for high-speed transmission links, e.g., PPP (Point-to-Point Protocol) link in SDH (Synchronous Digital Hierarchy)/SONET (Synchronous Optical Network) and OTN (Optical Transfer Network) links; GPF can even be used for bare optical fibers. For high-speed digital transmission environments, many conventional solutions such as ATM, FR (Frame Relay), PPP/HDLC and POS (PPP-over-SDH/SONET) can't meet the demand for network service development, while GFP is deemed as the best alternative.

FIG. 2(a) shows the role of GFP in the network, in which the relations between GFP and client data on higher layer as well as between GFP and lower transmission channels are shown clearly. GFP is divided into two layers; the upper layer relates to the client PDUs and refers as client-defined aspect of GFP, which is designed for encapsulation management of client data; the lower layer does not relates to client PDUs and refers as general aspect of GFP, which is designed for sending, receiving and controlling.

The payload overhead of GFP can be used for transmission in the same transmission channel in several transmission modes. The first mode, corresponding to GFP-F (Frame-Mapped GFP), is most suitable for packet switching environments; in this case, resource management is carried out by original data clients of resources; this mode is right the transmission mode for primary IP, PPP, and Ethernet services. The second mode, corresponding to GFP-T (Transparent GFP), is mainly designed for circuit emulation applications that are sensitive to time delay; the purpose is to implement effective transmission on adaptation layer. This mode is the transport model for FC (Fiber Channel), ESCON (Enterprise Systems Connection), and FICON (Fiber Connection) services.

At present, data of packet-switching traffics (e.g., IP traffic) is encapsulated and carried by FR, PPP/HDLC, POS or ATM, and then transmitted across the TDM-based core network. Though most edge routers, especially those in MANs and WANs, employ STM-16/OC-487c and STM-64/OC-192c SDH/SONET interfaces, most FR and PPP interfaces still work at the speed of DS1, DS3 or OC-3c, or even lower. Ethernet and SAN (Storage Area Network) protocols, such as FC, ESCON and FICON, are still proprietary protocols from suppliers, which are transmitted through the public network in traditional transmission plans. However, GFP supports QoS and is based on existing standard mechanisms; it transmits Ethernet/SAN traffic through TDM network, and thereby meets the requirement for improved interconnectivity between data center and SAN as well as the demand for Ethernet-based VPN and enhanced QoS functionality through 802.1Q/P.

FIG. 2(b) shows the role of GFP in the network structure, wherein the under-layer of the network employs a high data rate optical fiber network, e.g., WDM (Wave Division Multiplexing), OTN, etc., as the physical medium, on which a SONET or SDH network is constructed. Traditional HDLC, ATM, or GFP may be constructed on SONET/SDH; wherein ATM and GFP can also be constructed on the transmission medium. In traditional networks, an Ethernet is constructed over HDLC to carry IP traffic on network layer; IP services can also be carried over ATM, i.e., IPOA (IP-Over-ATM). However, GFP can also be configured in Ethernet mode or carry IP services and SAN services such as FC, ESCON, FICON, etc.

Seen from above, the existing network architectures carry PSN (Packet Switching Network) traffic, e.g., MPLS on the traditional data link layer, e.g., HDLC; therefore, the data link layer of any existing MPLS usually employs HDLC/PPP, FR, ATM or Ethernet; however, the data link layer of optical transmission network usually employs HDLC/PPP.

In practice, said solution has the following disadvantages: since data are encapsulated in PPP/HDLC mode and transmitted through the optical transmission network, the solution is complex, inefficient, unapt, and has direct and adverse effect to MPLS network performance.

The main cause of such a disadvantage is: existing MPLS networks employ traditional data link layer protocols or encapsulation methods, which can't fully meet the requirements of MPLS networks and can't adapt to the development of future network traffics.

### SUMMARY OF THE INVENTION

It is an object of the present invention to provide a method for transmitting MPLS PDUs to improve transmission efficiency, resource utilization and network performance of MPLS network traffics.

To attain said object, a method for transmitting MPLS PDUs according to the present invention comprises the steps of:

A. adding the pending MPLS PDU to PIA (Payload Information Area) field of said GFP data frame;

B. transmitting said GFP data frame to the destination node via a transmission network;

C. retrieving said MPLS PDU from the PIA field of said GFP data frame at destination node.

Wherein said step A further comprises the sub-step of:

Setting said UPI (User Payload Identifier) field of said GFP data frame to a predetermined value indicating that the present frame carries the MPLS PDU.

Said predefined value indicating that the present frame carries the MPLS PDU is Hex 0×07.

Said step C comprises the sub-step of:

Removing the header of said GFP data frame, and then retrieving the payload of said GFP data frame as said MPLS PDU.

further comprises the steps of:

before said MPLS PDU is added to the PIA field, encoding or compressing said MPLS PDU;

after said MPLS PDU is retrieved from said PIA field, decoding or decompressing said MPLS PDU.

Compared to existing technologies, the difference of the technical solution in present invention lies in: MPLS PDU is encapsulated in GFP frame format, the UPI of GFP frame is set to indicate that the present frame carries a MPLS PDU, and the frame is transmitted via optical transmission network.

Such difference brings obvious benefits, i.e., encapsulating MPLS PDUs in GFP frames reduces encapsulation overhead and time delay, increases network throughput, enhances QoS compatibility, simplifies implementation and execution, and improves MPLS network performance and QoS.

### BRIEF DESCRIPTION OF THE DRAWINGS

FIG. 1 is a schematic diagram of MPLS network structure;

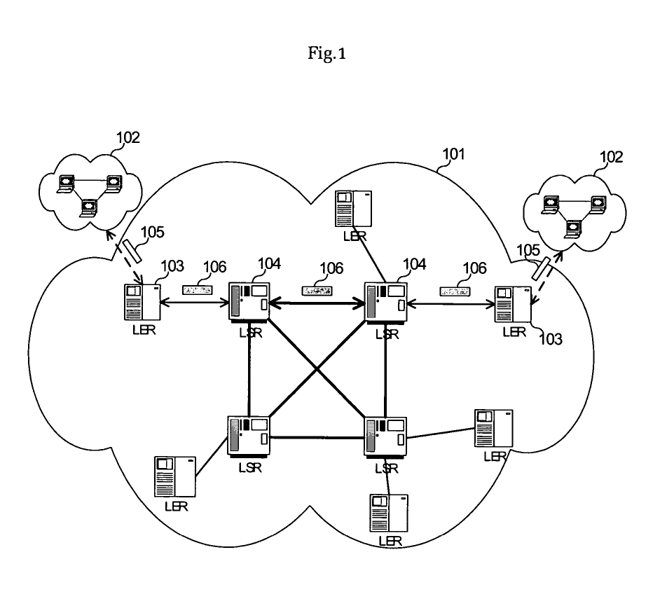

FIG. 2 shows the relation between GFP and network layers as well as role of GFP in the network architecture;

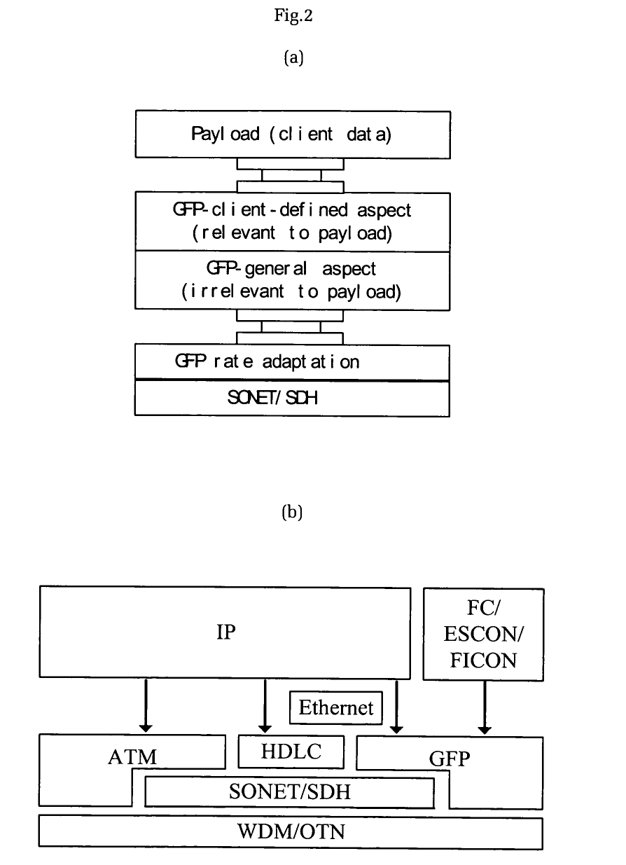

FIG. 3 is a schematic diagram of the GFP frame format designed to encapsulate MPLS PDUs according to an embodiment of the present invention.

### DETAILED DESCRIPTION OF THE EMBODIMENTS

The object, technical solution and benefits of the present invention will become more obvious through the description with reference to the attached drawings.

The present invention employs GFP protocol to encapsulate MPLS PDUs and transmits MPLS PDUs via the physical network to implement MPLS network traffic function. It enables MPLS network to incorporate GFP benefits such as simplicity, high efficiency, and flexibility and thereby improves performance of MPLS network.

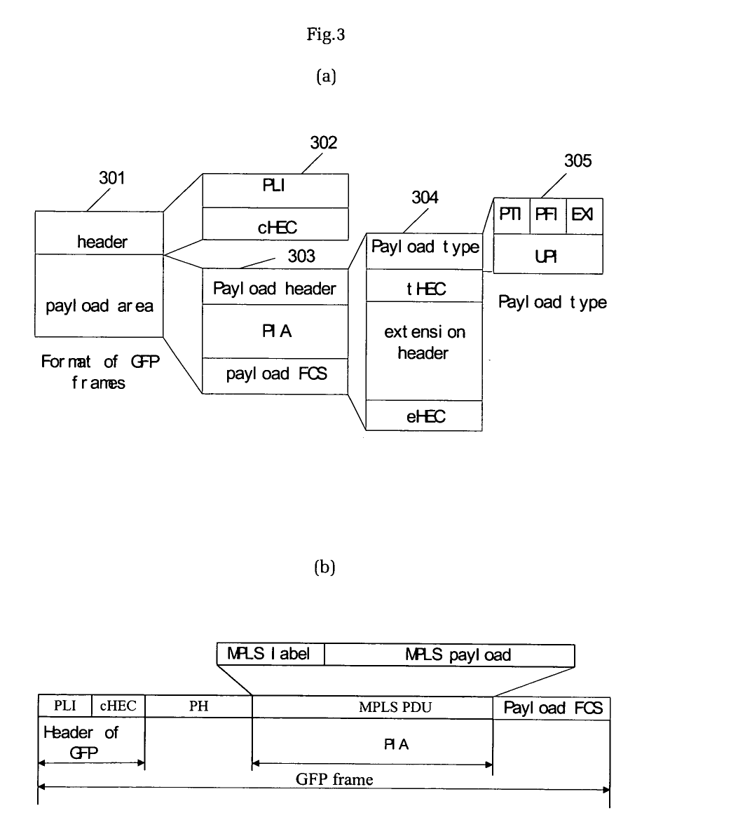

First, the present invention provides the format of the frame encapsulating MPLS PDUs in GFP protocol. FIG. 3 shows the format of GFP frame designed to encapsulate MPLS PDUs according to an embodiment of the present invention.

As shown in FIG. 3(a), a GFP frame 301 comprises a header 302 and a payload area 303; wherein the header 302 occupies 32 bits and is designed to describe GFP frame, independent to high level PDUs; the payload area 303 can occupy 4 to 65535 bytes and is designed to carry high level PDUs and relevant information.

In more detail, the header 302 further comprises PLI (Payload Length Indicator) and cHEC (Core Header Error Check). Wherein PLI occupies 16 bits and is designed to indicate byte number of the payload area 303; cHEC occupies 16 bits and is designed to detect data integrity of header 302 through 16-bit CRC (Cyclic Redundancy Check).

The payload area 303 comprises PH (Payload Header) 304, PIA and FCS (Frame-Check Sequence). Wherein PH can occupy 4 to 64 bytes and is designed to support data link management of high level client data; the total length of PIA and FCS can't go beyond 65536 bytes, wherein PIA is encapsulated high level client data; FCS is optional, occupies 4 bytes and is designed to perform 32-bit CRC for PIA.

PH 304 further comprises Payload Type 305, tHEC (Type HEC), Extension Header and eHEC (Extension HEC). Wherein Payload Type 305 occupies 16 bits and is designed to indicate content and format of PIA of GFP frame; tHEC occupies 16 bits and is designed to detect data integrity of Load Type 305 and supports single-bit error correction and double-bit error detection; Extension Header is optional and occupies 0 to 60 bytes and is designed to support header information of data link technical specifications, e.g., virtual connection identifier, source/destination address, port number and GoS; eHEC is also optional and occupies 16-bit CRC code for the Extension Header.

Payload Type 305 comprises 4 parts, i.e., PTI (Payload Type Identifier), PFI (Payload FCS Indicator), EXI (Extension Header Identifier), and UPI according to sending sequence; wherein 3-bit PTI is designed to indicates GFP client frame type, binary 000 for client data frame, and binary 100 for client management frame; 1-bit PFI indicates whether payload FCS exists; 4-bit EXI indicates type of the Extension Header; 8-bit UPI is designed to indicate payload type of PIA of the GFP frame. When PTI=000 (binary), i.e., client data frame, the following payload types are defined: Ethernet in frame-mapped mode, PPP in frame-mapped mode, FC in transparent mode, FICON in transparent mode, ESCON in transparent mode, KM Ethernet in transparent mode, and MAPOS (multiple access protocol over SDH) in frame-mapped mode. Wherein the following values (in Hex) are reserved in the value space of UPI: 0×00 and 0×FF: unobtainable; 0×07: reserved for future; 0×09˜0×EF: reserved for standardization in the future; 0×F0˜0×FE: reserved for intellectual property.

Hereunder the method for encapsulating MPLS PDU in above GFP is described in detail according to an embodiment of the present invention, with reference to FIG. 3(b). MPLS PDU is directly added to PIA of GFP data frame. The GFP frame for encapsulating MPLS PDU comprises the following parts according to sending sequence: PLI, header CRC, PH, PIA (i.e., MPLS PDU), and payload FCS; wherein MPLS PDU comprises MPLS label and MPLS payload according to sending sequence. The GFP frame will carry MPLS PDU after above encapsulation. Those skilled in the art can understand that the MPLS PDU can be added to GFP frame in any other way, e.g., perform addition after encoding and compression to achieve encapsulation of MPLS PDU in the GFP frame, without affecting the nature and scope of the present invention.

In an embodiment of the present invention, the UPI of GFP frame that encapsulates MPLS PDU is set to 0×07 to indicate that what the frame carries is MPLS PDU. Those skilled in the art can understand that the UPI of GFP frame can be defined as any applicable value to indicate that what the frame carries is MPLS PDU without affecting nature and scope of the present invention.

In an embodiment of the present invention, the method for transmitting MPLS traffics via optical transmission network comprises the steps of:

First, encapsulating the pending MPLS PDU in GFP frame through adding the MPLS PDU in PIA of GFP frame, and assigning values to other fields of the GFP frame;

Second, setting the UPI field of GFP frame a predefined value to indicate that what the frame carries is MPLS PDU; wherein the predefined value can be 0×07 or any other applicable value;

Next, transmitting the encapsulated GFP frame to the destination node via optical transmission network. During transmission of the GFP frame, the intermediate nodes can identify MPLS PDU carried in the frame according to UPI field and carry out correct processing for the frame.

Finally, retrieving the MPLS PDU from GFP frame at the destination node, which is a decapsulation process, a reverse process of above encapsulation process and is designed to remove GFP header and retrieve the payload. It should be noted that only two types of link layer technologies carrying MPLS PDUs are available before, i.e., Ethernet MAC and PPP protocols. Now GFP is added as an option to transmit MPLS efficiently via SDH/SONET.

Though the present invention is shown and described with reference to some preferred embodiments, those skilled in the art should understand that various modifications to the present invention can be made without departing from the spirit and scope of the present invention.

1. A method for transmitting MPLS (Multi-protocol Label Switch) PDUs (Protocol Data Unit), comprising steps of:
A) adding pending MPLS PDU to PIA (Payload Information Area) field of a GFP (General Framing Procedure) data frame;
B) transmitting said GFP data frame to a destination node via a transmission network;
C) retrieving said MPLS PDU from the PIA field of said GFP data frame at destination node.

2. A method for transmitting MPLS PDUs according to claim 1, wherein said step A further comprises a sub-step of:
setting said UPI (User Payload Identifier) field of said GFP data frame to a prearranged value indicating that the present frame carries the MPLS PDU.

3. A method for transmitting MPLS PDUs according to claim 2, wherein said predefined value indicating that the present frame carries the MPLS PDU is Hex 0×07.

4. A method for transmitting MPLS PDUs according to claim 1, wherein said step C comprises a sub-step of:
removing the header of said GFP data frame, and then retrieving a payload of said GFP data frame as said MPLS PDU.

5. A method for transmitting MPLS PDUs according to claim 1, further comprising steps of:
before said MPLS PDU is added to the PIA field, encoding or compressing said MPLS PDU;
after said MPLS PDU is retrieved from said PIA field, decoding or decompressing said MPLS PDU.

6. A method for transmitting MPLS PDUs according to claim 1, wherein said GFP is defined in Proposal G 7041/Y 1303 of ITT.

7. A method for transmitting MPLS PDUs according to claim 1, wherein said transmission network is an optical transmission network.
